(19) United States
(12) Patent Application Publication
(10) Pub. No.: US 2006/0048156 A1
(43) Pub. Date: Mar. 2, 2006

(54) Unified control store

(76) Inventors: Soon Chieh Lim, Penang (MY); Ying Wei Liew, Penang (MY); Loo Shing Tan, Penang (MY)

Correspondence Address: FISH & RICHARDSON, PC, P.O. BOX 1022, MINNEAPOLIS, MN, 55440-1022, US

(21) Appl. No.: 10/817,733

(22) Filed: Apr. 2, 2004

(51) Int. Cl. G06F 9/46

(52) U.S. Cl. 718/102

(57) ABSTRACT

A system and method includes providing a unified control store accessed by a plurality of engines. The control store includes a plurality of sequences of instructions. The system and method also includes assigning a program pointer for a particular engine. The program pointer points to a particular sequence of instructions. The system and method includes dynamically reassigning the program pointer to point to a different sequence of instructions.

### BACKGROUND

A computer system can send packets from one system to another system over a network. The network generally includes a device such as a router that classifies and routes the packets to the appropriate destination. Often the device includes a control processor or network processor. Typically, the network processor includes multiple engines that process the network traffic. Each engine performs a particular task and includes a set of resources, for example, a control store for storing instruction code.

### DESCRIPTION OF DRAWINGS

FIG. 1 is a block diagram of a system.

FIG. 2 is a block diagram of a network processor including multiple engines.

FIG. 3 is a block diagram of the assignment of a thread in an engine of a network processor.

FIG. 4 is a flow chart of a process for dynamic task scheduling in an engine performing classification.

FIG. 5 is a flow chart of a process for dynamic task scheduling in an engine that contains idle threads.

FIG. 6 is a block diagram of a system including multiple engines each including a cache.

### DESCRIPTION

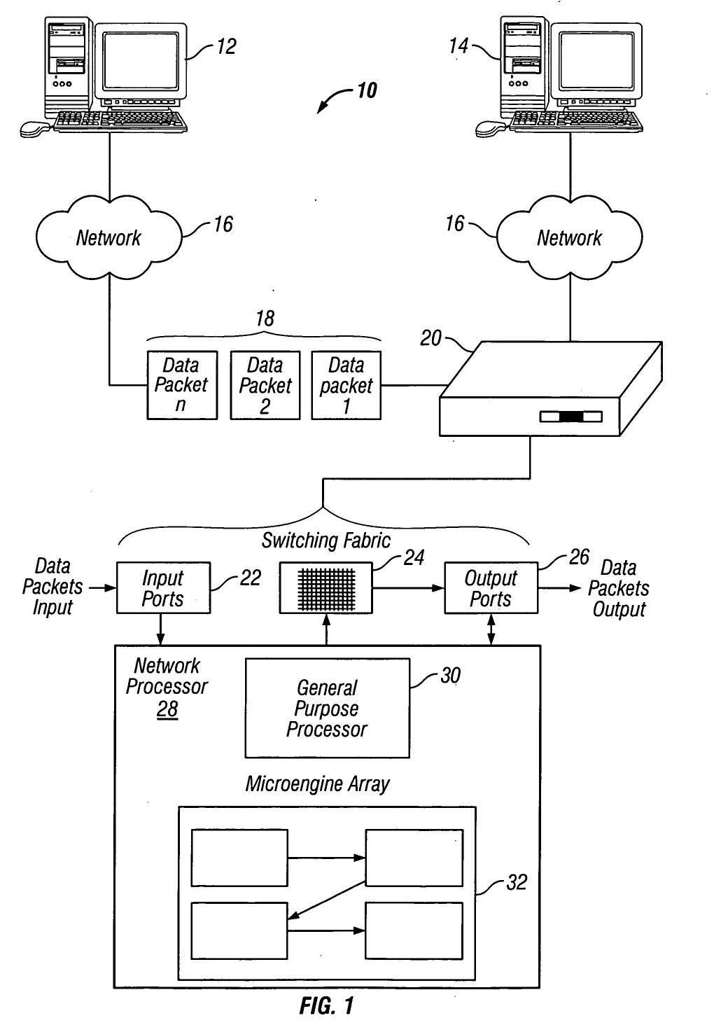

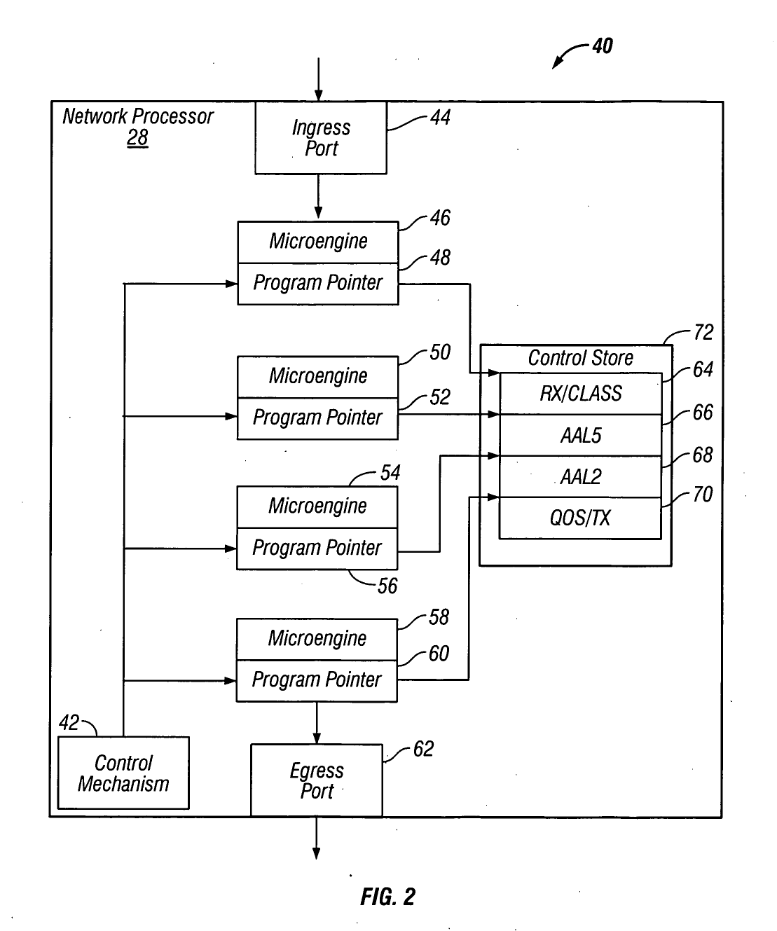

Referring to FIG. 1, a system 10 for transmitting data from a computer system 12 through a network 16 to another computer system 14 is shown. System 10 includes a networking device 20 (e.g., a router or switch) that collects a stream of “n” data packets 18 and classifies each of the data packets for transmission through the network 16 to the appropriate destination computer system 14. To deliver the appropriate data to the appropriate destination, the networking device 20 includes a network processor 28 that processes the data packets 18 with an array of, for example, four, (as illustrated in FIG. 2) or six or twelve, and so forth programmable multithreaded engines 32. An engine can also be referred to as a processing element, a processing engine, microengine, picoengine, and the like. Each engine executes instructions that are associated with an instruction set (e.g., a reduced instruction set computer (RISC) architecture) and can be independently programmable. In general the engines and general purpose processor are implemented on a common semiconductor die, although other configurations are possible.

Typically, a networking device 20 receives the data frames 18 on one or more input ports 22 that provide a physical link to the network 16. The networking device 20 passes the frames 18 to the network processor 28, which processes and passes the data frames 18 to a switching fabric 24. The switching fabric 24 connects to output ports 26 of the networking device 20. However, in some arrangements, the networking device 20 does not include the switching fabric 24 and the network processor 28 directs the data packets to the output ports 26. The output ports 26 are in communication with the network processor 28 and are used for scheduling transmission of the data to the network 16 for reception at the appropriate computer system 14. A data frame may be a packet, for example a TCP packet or IP packet.

Referring to FIG. 2, the network processor 28 includes a unified control store 72 that is accessed by multiple engines 46, 50, 54, and 58. The unified control store 72 includes application specific code and instructions accessed by the engines 44, 50, 54, and 58 to perform specific tasks. For example, control store 72 includes an instruction set for action related to tasks required by an application such as ATM adaptation layer 2 (AAL2) processing 68, ATM adaptation layer 5 (AAL5) processing 66, packet classification 64, and quality of service (QOS) actions 70. In control store 72 programs can be variable in size. This may provide an advantage of maximizing the memory allocation efficiency since control store space is not wasted for small programs and large programs do not have to be divided into smaller programs to conform to space limitations.

An engine can be single-threaded or multi-threaded (i.e., executes a number of threads). When an engine is multi-threaded, each thread acts independently as if there are multiple virtual engines. Each engine 46, 50, 54, and 58 (or the threads of a multi-threaded engine) includes a program pointer 48, 52, 56, and 60 that points to the location in the control store 72 of the code or instructions for a specific task. For example, the program pointer 52 of engine 50 points to a location in the control store 72 with instructions 66 for AAL5 processing.

During start-up of the system, engines 44, 50, 54, and 58 are assigned a program pointer that points to a specific code area in the unified control store 72. This configures each engine to perform a particular task. For example, in FIG. 2, engine 46 is assigned to classification code 64, engine 50 is assigned to AAL5 code 66, engine 54 is assigned to AAL2 code 68, and engine 58 is assigned to QOS code 70. A programmer or user determines the assignment of pointers at startup based on estimated usage or based on other criterion.

The program pointers 48, 52, 56, and 60 for engines 44, 50, 54, and 58 can be dynamically reassigned. When a program pointer for a particular engine is reassigned, the task performed by the engine changes (e.g., the engine executes the instructions stored at the location in the control store pointed to by the pointer that was reassigned to another engine). A control mechanism 42 dynamically reassigns the pointers. The control mechanism 42 reassigns the pointers based on the packets received or based on other information such as engine processing load. The dynamic reassignment of program pointers for the engines allows dynamic allocation of tasks among the multiple engines without rebooting the network processor 28. In some examples, dynamic task allocation may provide advantages. For instance, dynamic reassignment allows the network processor 28 to operate efficiently because the workload can be distributed amongst all available resources.

In one example, the control mechanism 42 monitors the proportion of packets entering the network processor for different tasks. If the control mechanism 42 determines that a large percentage of the packets are AAL2 packets and a low percentage are AAL5 packets, the control mechanism 42 reassigns the program pointer 56 of engine 54 (or a pointer for another engine) to point to the AAL2 instruction set 66 in the control store 72. The control mechanism 42 monitors and reassigns program pointer, e.g., 52 to point to the control store location where AAL2 instructions are stored. Thus, the instructions used by the engine 50 will be instructions to process AAL2 packets and engine 50 will process the next AAL2 packet. The control mechanism waits until a task currently running on engine 50 is complete before changing the program pointer 52. The engine 50 continues to execute the same instruction pointed to by the program pointer 52 for different incoming data frames until the control mechanism 42 changes the program pointer 52 of the engine 50.

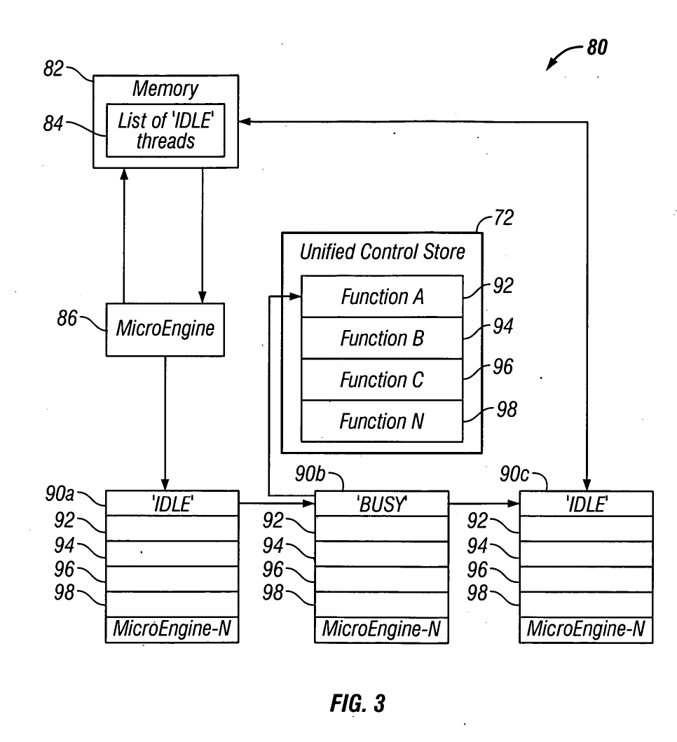

Referring to FIG. 3, a system 80 for dynamic task scheduling in the engines of a network processor 28 based on threads is shown. A multi-threaded engine includes a number of threads (e.g. threads 90, 92, 94, 96, and 98). A control mechanism assigns threads in an engine to perform different tasks. In the network processor, one engine (e.g., engine 86) is statically assigned to perform the control mechanism by receiving a packet and classifying the packet based on information included in the header of the packet. Each thread in engine 86 is assigned to perform the classification process.

Other engines in system 80 execute multiple threads. The threads for the engines are referred to collectively as a ‘pool of threads.’ Within the pool of threads, each thread is associated with a status register. The status of a thread is stored in a common area (accessible by the control mechanism), for example, the status register can be stored as bits in a central register of the network processor. Alternately, the bits used to indicate the status can be local to a thread or an engine and accessible such that the control mechanism can access to the status registers to determine when to assign tasks to the threads.

The status register indicates status of the particular thread with which the register is associated. For example, the register indicates if the thread is executing an instruction or if the thread is in an idle state. For example, status indications can include ‘IDLE’ and ‘BUSY’. An ‘IDLE’ status indicates that the engine or thread is in an idle state and not executing any function. A ‘BUSY’ state indicates that the engine or thread is currently executing a function. An additional status of ‘ASSIGNED’ can be kept in the status registers and used to indicate threads to which a packet has been allocated for processing, but for which the processing has not yet begun. The status register of the thread or engine is updated during processing to indicate the correct status for the thread.

System 80 also includes a memory 82 with a list 84 of ‘IDLE’ threads. Threads with an ‘IDLE’ status are included in the list 84 of ‘IDLE’ threads. Engine 86 references the list 84 to determine which threads in the pool of threads are available to process a packet.

For example, in FIG. 3, engine 86 determines that thread 90a is in the ‘IDLE’ state. Engine 86 subsequently assigns thread 90a to perform function ‘A’ 92 by changing the program pointer of thread 90a to point at the address of function ‘A’ 92 in the unified control store. The state of thread 90a is changed to ‘BUSY’ 90b to indicate that the thread is currently executing a function. Once thread 90b has finished its execution, its state is changed back to ‘IDLE’ 90c.

Some systems process packets differently based on a priority indication. If a priority system is used, a thread with an ASSIGNED status register can be preempted from processing the currently assigned packet to process a different packet with a higher priority. A thread with a ‘BUSY’ status, however, is generally not reassigned based on priority of another packet. Once the busy thread has finished executing the assigned task, the status register is set to ‘IDLE’. When the status is ‘IDLE’, another packet may be assigned to the thread for processing.

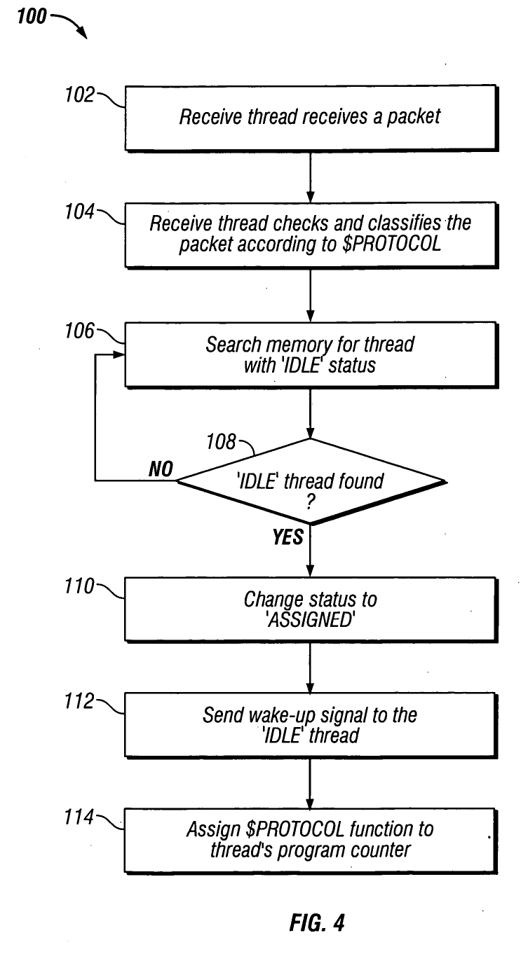

Referring to FIG. 4, a process 100 for assignment of a packet to a particular thread in an engine for processing is shown. This process is executed by engine 86, for example, or by another engine used for packet classification and task allocation. Process 100 receives 102 a packet and the receive thread classifies 104 the packet according information needed for processing the packet (e.g., as indicated by the “PROTOCOL”) or other information included in the header of the packet.

Engine 86 searches 106 the memory 82 for a thread with an ‘IDLE’ status. Process 100 determines 108 if an ‘IDLE’ thread is found. If an ‘IDLE’ thread is not found, process 100 continues to search 106 the memory until an ‘IDLE’ thread is found. If an ‘IDLE’ thread is found, process 100 changes 110 the status of the thread from ‘IDLE’ to ‘ASSIGNED.’ Process 100 sends 112 a signal (e.g., a wakeup signal) to the thread and assigns 114 the PROTOCOL function to the thread's program counter. Since the program counter has been assigned, the thread's program counter now points to a particular function code in the unified control store 72 in FIG. 2.

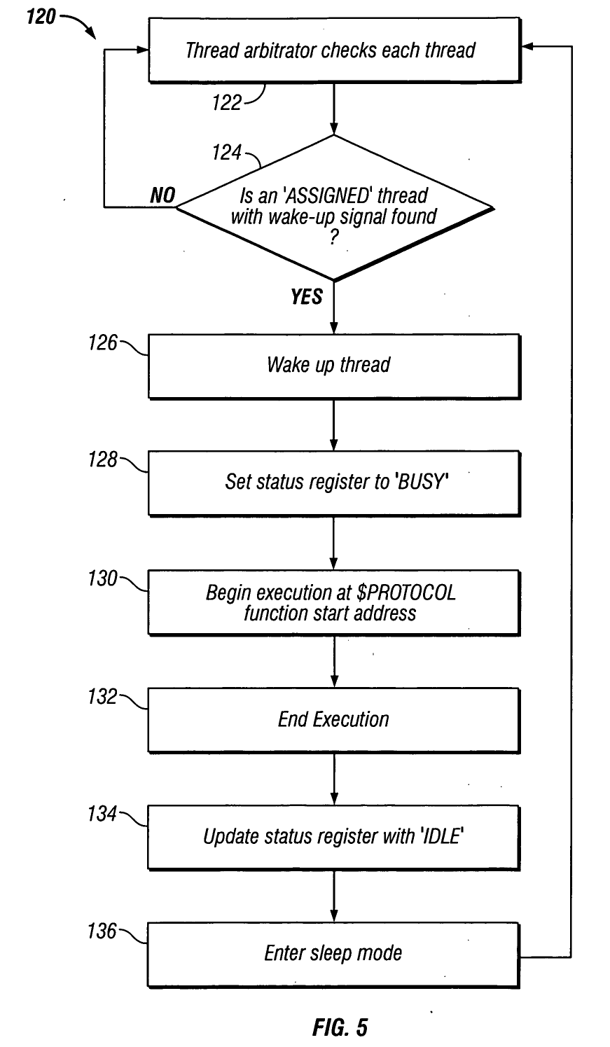

Referring to FIG. 5, a process 120 that executes on an engine is shown. Process 120 includes a thread arbitrator that checks 122 each thread and determines 124 if any threads with an ‘ASSIGNED’ status and that have received a wakeup signal are in the idle list 84 (FIG. 3). If no threads are found, process 120 returns to checking 122 the threads. If a thread with an ‘ASSIGNED’ status that has been sent a wakeup signal is found, process 120 activates 126 (e.g., wakes up) the thread. Process 120 sets 128 the status register of the thread to ‘BUSY.’ Process 120 begins 130 execution and processing of the packet at the PROTOCOL function's start address (e.g., the location pointed to by the program pointer). Subsequent to processing the packet, process 120 ends 132 the execution, updates 134 the status register for the thread to ‘IDLE’, and enters 136 a sleep mode.

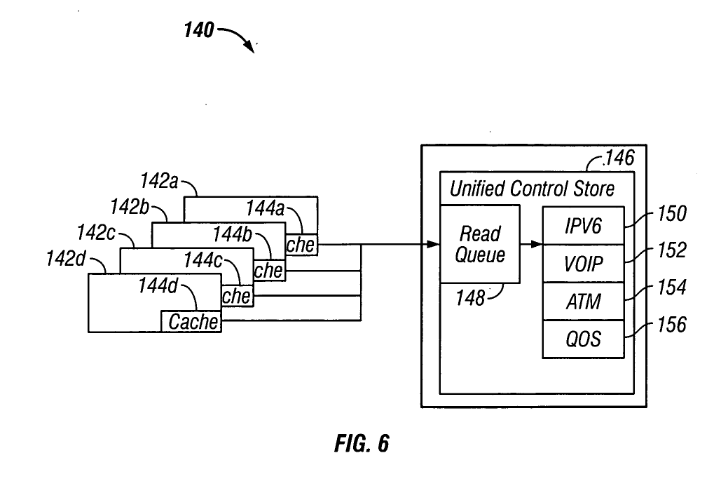

Referring to FIG. 6, another example of a system 140 including multiple engines 142 and a unified control store 146 is shown. In this example, each engine 142 includes a cache 144. The size of the cache can be large enough to store the largest single function in the unified control store 146. The unified control store 146 can be single ported (e.g., port 145), but having a queue 148 in the interface with the engines to sequentially serve the engines. If the program pointer of a particular engine points to a code address not found in the cache 144, the cache 144 accesses the unified control store 146. Since the dynamic scheduling mechanism does not force the program pointer of an engine 142 to change each time a packet arrives, the latency incurred for accessing the unified control store less significant. The use of an internal cache 144 for each engine 142 can reduce the memory access latency to the control store. For example, without the cache the latency could be large (>10 cycles) because multiple engines share a single control store.

While in the examples above, four engines were shown, any number of engines could be used. While in the examples above, three status indications (idle, busy, and assigned) were described, other status indications could be used in addition to or instead of the described set of status indications.

A number of embodiments have been described, however, it will be understood that various modifications may be made. Accordingly, other embodiments are within the scope of the following claims.

What is claimed is:

1. A method comprising:
providing a control store accessed by a plurality of engines, the control store including program code for execution on the plurality of engines;
assigning a program pointer for a particular engine, the program pointer pointing to a sequence of instructions; and
dynamically reassigning the program pointer to point to a different sequence of instructions during runtime.

2. The method of claim 1 wherein the plurality of engines are included in a network processor, the method further comprising dedicating one of the plurality of engines for packet classification.

3. The method of claim 1 wherein assigning the program pointer includes assigning the program pointer during an initialization cycle.

4. The method of claim 1 further comprising:
monitoring the status of an engine; and
reassigning the pointer based on the status.

5. The method of claim 1 wherein dynamically reassigning the pointer includes dynamically re-assigning the pointer based on information included in a packet.

6. The method of claim 1 further comprising storing a status indication for each of the plurality of engines and sending a packet to a particular engine based on the status indication.

7. The method of claim 6 wherein the status indication is selected from the set consisting of idle, assigned, and busy.

8. The method of claim 6 further comprising sending a wakeup signal to a particular engine having an idle status indication; and
changing the status indication of the engine to assigned.

9. The method of claim 1 wherein the engine is a single threaded engine.

10. The method of claim 1 wherein the engine is a multi-threaded engine and assigning the program pointer for the particular engine includes assigning the program pointer for a particular thread of the engine.

11. The method of claim 1 further comprising:
providing an engine memory in a particular engine, and copying a particular program code pointed to by the program pointer for the particular microengine from the control store to the engine memory.

12. A device comprising:
a control store accessed by a plurality of engines, the control store including a plurality of sequences of instructions;
a plurality of engines,
a control mechanism to assign a program pointer for a particular engine, the program pointer pointing to a particular sequence of instructions that dynamically reassigns the program pointer to point to a different sequence of instructions.

13. The device of claim 12 wherein the control mechanism is configured to assign the program pointer during an initialization cycle.

14. The device of claim 12 wherein the control mechanism monitors the status of an engine and reassigns the pointer based on the status.

15. The device of claim 12 further comprising a register to store a status indication for each of the plurality of engines to allow the control mechanism to send a packet to a particular engine based on the status indication.

16. The device of claim 12 wherein the engine is a single threaded engine.

17. The device of claim 12 wherein the engine is a multi-threaded engine the device, and the control store is further configured to assign the program pointer for a particular thread of the engine.

18. A system comprising:
a router; and
a network processor, the network processor configured to:
access a plurality of sequences of instructions from a control store, the control store coupled to a plurality of engines and storing the plurality of sequences of instructions;
assign a program pointer for a particular engine, the program pointer pointing to a particular sequence of instructions; and
dynamically reassign the program pointer to point to a different sequence of instructions.

19. The system of claim 18 wherein the network processor is further configured to assign the program pointer during an initialization cycle.

20. The system of claim 18 wherein the network processor is further configured to:
monitor the status of an engine; and
reassign the pointer based on the status.

21. The system of claim 18 wherein the network processor is further configured to store a status indication for each of the plurality of engines and send a packet to a particular engine based on the status indication.

22. The system of claim 18 wherein the engine is a multi-threaded engine the network processor is further configured to assign the program pointer for a particular thread of the engine.

23. The system of claim 18 wherein the router includes a switching fabric.

24. The system of claim 18 wherein the router includes a general-purpose processor.

25. The system of claim 18 wherein the network processor is included in the router.

26. A computer program product, tangibly embodied in an information carrier, for executing instructions on a processor, the computer program product being operable to cause a machine to:
access a plurality of sequences of instructions from a control store, the control store coupled to a plurality of engines and storing the plurality of sequences of instructions;
assign a program pointer for a particular engine, the program pointer pointing to a particular sequence of instructions; and
dynamically reassign the program pointer to point to a different sequence of instructions.

27. The computer program product of claim 26 further comprising instructions to cause a machine to assign the program pointer during an initialization cycle.

28. The computer program product of claim 26 further comprising instructions to cause a machine to monitor the status of an engine and reassign the pointer based on the status.

29. The computer program product of claim 26 further comprising instructions to cause a machine to:
store a status indication for each of the plurality of engines; and
send a packet to a particular engine based on the status indication.

30. The computer program product of claim 26 wherein the engine is a multi-threaded engine, the computer program product further comprising instructions to cause a machine to:
assign the program pointer for a particular thread of the engine.
